(19) United States
(12) Patent Application Publication
(10) Pub. No.: US 2025/0307009 A1
(43) Pub. Date: Oct. 2, 2025

(54) ADAPTIVE RESOURCE ALLOCATION FOR MACHINE LEARNING WORKFLOWS

(71) Applicant: THE TORONTO-DOMINION BANK, TORONTO (CA)

(72) Inventors: Alexander Clarence, TORONTO (CA); Raunaq Suri, Mississauga (CA); Ding Tao Liu, TORONTO (CA); Satya Krishna Gorti, TORONTO (CA); Guangwei Yu, TORONTO (CA)

(21) Appl. No.: 19/093,559

(22) Filed: Mar. 28, 2025

Related U.S. Application Data
(60) Provisional application No. 63/571,143, filed on Mar. 28, 2024.

(51) Int. Cl. G06F 9/50

(52) U.S. Cl. CPC G06F 9/5027

(57) ABSTRACT

An execution system enables flexible execution of machine learning process pipelines by generating machine learning workflows with dispatchable workflow components. The execution system identifies process logic components of machine learning process pipelines, where each process logic component is a machine learning model or other data processing function. The execution system generates a machine learning workflow including dispatchable workflow components. Each dispatchable workflow component includes a process logic component, execution wrapper, and dispatch configuration, each of which is logically separate and may be individually modified. The execution system coordinates execution of the dispatchable workflow components by transmitting instructions to worker environments to execute the components. The worker environments may be selected based on requirements or performance of each dispatchable workflow component.

### CROSS REFERENCE TO RELATED APPLICATION

This application claims priority to U.S. Provisional Patent Application No. 63/571,143, filed Mar. 28, 2024, which is incorporated by reference herein in its entirety for all purposes.

### BACKGROUND

This disclosure relates generally to machine learning models, and more specifically to a system for management and execution of machine learning process pipelines.

Machine learning process pipelines may be used in various industries and applications to generate information or predictions for downstream processes. Often, machine learning process pipelines are composed of multiple logical steps or “components,” that may individually be a machine learning model or other process logic configured to receive input data and generate output data. Within a machine learning process pipeline, the output data of one process logic component may be used as the input data to a next process logic component, creating dependencies between process logic components of the machine learning process pipeline, such that a later process logic component of the pipeline cannot be executed until successful execution of a previous process logic component.

As machine learning process pipelines increase in complexity and dependency, process logic components within pipelines are often subject to different resource requirements and processing needs. For example, process logic components intended to convert raw data into samples (e.g., input features characterizing a data sample) on which subsequent machine learning models are applied may be memory intensive, as they typically load and transform large amounts of data, while other components applying model layers may comparatively benefit from or require higher or different processing resources. For example, certain computer model architectures and/or layers may benefit from execution on processors with enhanced capacity for parallel processing or matrix operations. Likewise, some pipelines or components of pipelines may be subject to more rigorous observability or auditing requirements when deployed in various execution circumstances, such that some process logic components may be monitored in different ways than others. These various requirements and dependencies may mean that process logic components of a machine learning process pipeline are more or less suited to particular systems or environments for execution and with different execution circumstances, which may not always coincide with other process logic components of the same pipeline and may lead to suboptimal performance within a pipeline.

Additionally, development of machine learning process pipelines often requires collaborative effort from various data scientists (generating ML pipelines), software engineers (coordinating execution monitoring), and DevOps engineers (deploying ML systems to various cloud infrastructures). Due to the varying complexity of machine learning process pipelines, a lack of clear boundaries in how machine learning process pipelines are created and executed may lead to overlapping or confusing responsibilities and increase inefficiencies when implementing ML pipelines in practical environments.

### SUMMARY

An execution system enables flexible execution of machine learning process pipelines by generating machine learning workflows comprising dispatchable workflow components and orchestrating dispatch and execution of the dispatchable workflow components based on resource requirements and dependencies between the dispatchable workflow components. Remote workspaces or “worker environments” such as cloud computing services may provide resources or provide other benefits such as standardized container environments, dynamic provision of additional resources, and so forth. However, the dispatch of process logic components to worker environments introduces the need for more precise orchestration to ensure that data dependencies between process logic components are correctly maintained. Similarly, dispatch of process logic components requires that all necessary elements of a dispatched process logic component are accessible to a worker environment and all necessary elements of a dispatched process logic component are configured correctly for the particular worker environment.

An orchestrator of the execution system coordinates execution of a machine learning process pipeline by resolving dependencies between process logic components and creating dispatchable workflow components to be run. To ensure that workflow components are configured correctly for different worker environments, the orchestrator generates workflow components for each process logic component of the machine learning process pipeline. Each workflow component includes: the respective process logic component, an execution wrapper, and a dispatch configuration. The process logic component represents individual components for the execution logic of the machine-learning pipeline, such as processing or machine-learning layers that transform or process an input to a respective workflow component into an output. The execution wrapper specifies pre-and post-execution logic (relative to the process logic component), including, for example, monitoring or auditing functions, generating metadata for the input or output data such as timestamps, identifiers, and the like. The dispatch configuration provides configuration information specific to execution environments, such as credentials, input and output storage locations, networking and system configurations, and so forth.

In some embodiments, the orchestrator establishes communication channels between itself, the worker environments, and a shared storage location. In some embodiments, the orchestrator transmits instructions to execute dispatchable workflow components to the worker environments and monitors the shared storage location for changes. Worker environments can thus access data from the shared storage location to execute workflow components, and to store output data from execution into the shared storage location, while the orchestrator determines that execution is complete when the output data appears in the shared storage location. In these embodiments, the orchestrator thus provides one-way signaling to the worker environment to dispatch workflow components and uses changes to the storage location to determine whether there was successful execution of workflow components (rather than receiving a confirmation from the worker environment).

The logical separation of elements within workflow components allows the execution system to modify elements of each workflow component as needed without modification of the other elements within the same workflow component. That is, a dispatch configuration associated with a first worker environment for a workflow component may be replaced with a new dispatch configuration associated with a second worker environment to accommodate a change in dispatch, while the execution wrapper and process logic for the workflow component is not modified. Likewise, developers or other users may modify the process logic of a workflow component (e.g., to introduce new code or updated model parameters) without modifying the execution wrapper or dispatch configuration for the same workflow component.

The logical separation of elements within workflow components and ability to dispatch workflow components to environments based on resource requirements and dependencies provides a more flexible framework for executing machine learning process pipelines.

### BRIEF DESCRIPTION OF THE DRAWINGS

FIG. 1 is an example environment for an execution system, according to one embodiment.

FIG. 2 is an example block diagram of an execution system, according to one embodiment.

FIG. 3A-D illustrates an example machine learning process pipeline and generation of a respective machine learning workflow, according to one embodiment.

FIGS. 4A-B are an example timing diagram for executing a machine learning workflow by an execution system, according to one embodiment.

FIG. 5 is an example flow diagram illustrating a method for generating and executing a machine learning workflow, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Architecture Overview

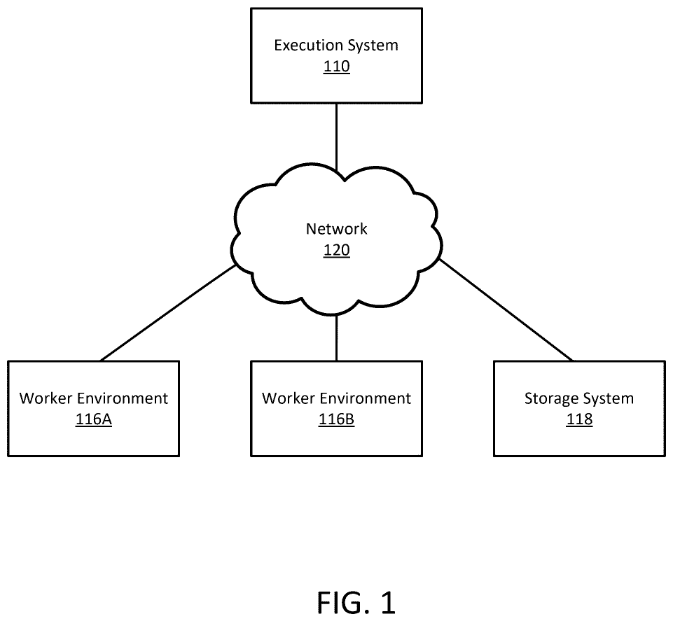

FIG. 1 is an example environment 100 for an execution system 110, according to one embodiment. The execution system 110 orchestrates execution of machine learning process pipelines across one or more workspaces via communication through a network 120 with one or more worker environments 116 and a storage system 118. The network 120 provides a communication channel between the execution system 110, the worker environments 116, and the storage system 118. In other embodiments, different and/or additional components may be included in the system environment 100, and one or more components may perform different functions.

Application of a machine learning model may require multi-step application of various processes, such as data collection and processing, machine model layers in sequence or in parallel, and so forth. The set of these processes for an individual application of a machine learning model may be referred to as a machine learning process pipeline. Machine learning process pipelines, which may be created in one or more upstream processes or systems, are composed of multiple logical steps or process logic components. Process logic components may include a machine learning model trained to transform or process input data to generate an output, or may be any other data processing step or function that form steps of applying a machine learning model. For example, process logic components may be one or more of: a generalized linear model, a generalized additive model, a random forest classifier, a spatial regression operation, a Bayesian regression model, a time series analysis, a Bayesian network, a Gaussian network, a decision tree learning operation, an artificial neural network, a recurrent neural network, a reinforcement learning operation, linear or non-linear regression operations, clustering operations, support vector machines, or genetic algorithm operations. In other examples, process logic components may be used to pre-process data prior to inputting the data to a downstream machine learning model, or to post-process data output by an upstream machine learning model, such as: data smoothing or formatting; gathering, cleaning, consolidating data; generating data features or embeddings; or the like.

Often, in complex machine learning process pipelines, process logic components may depend on previous process logic components within the machine learning process pipeline, such that the output data of one process logic component is used as an input for a next process logic component. Process logic components may have multiple dependencies from multiple previous process logic components, such that the dependent process logic components cannot be executed without the previous process logic components successfully executing first.

In the embodiment of FIG. 1, the execution system 110 orchestrates execution of machine learning process pipelines by generating machine learning workflows and dispatching workflow components of the machine learning workflows to worker environments. The execution system 110 receives machine learning process pipelines and identifies the set of process logic components of the machine learning process pipeline, including any data dependencies associated with each identified process logic component. In addition, the process logic components, as used herein, typically provide processing steps (e.g., as executable code or binary) related to application of the machine learning pipeline without side effects.

The execution system 110 may additionally identify any resource requirements or data processing needs associated with each process logic component, e.g., whether a process logic component is memory intensive, and/or whether a process logic component is subject to auditing or monitoring requirements. These various requirements may determine additional execution characteristics such as whether one or more systems or environments of the various worker environments 116 (or a local environment of the execution system 110) is better suited for execution of the process logic component or whether additional monitoring components should be included with execution of process logic components.

The execution system 110 uses the set of process logic components to generate a machine learning workflow. The machine learning workflow is composed of a set of dispatchable workflow components, each corresponding to the set of process logic components. Each dispatchable workflow component may be dispatched to a suitable worker environment 116 or to a storage system 118 independently of other dispatchable workflow components within the same machine learning workflow, enabling the execution system 110 to select an appropriate suitable work environment for each dispatchable workflow component. The dispatchable workflow components include the respective process logic component, an execution context, and a dispatch configuration. The execution context dictates pre-and post-execution logic, including, for example, monitoring or auditing functions, generating metadata for the input or output data such as timestamps, identifiers, and the like. The dispatch configuration provides configuration information specific to execution environments, such as instructions encoded for specific worker environments 116.

In various embodiments, elements of a dispatchable workflow component (the process logic, the execution context, and the dispatch configuration) are logically separate from each other element of the same dispatchable workflow component. As the process logic provides the execution logic for the machine learning process pipeline (without additional side effects), the execution context and dispatch configuration provide additional side effects, monitoring, and further characteristics to the execution of the dispatchable workflow component. In addition, the execution system 110 may later modify elements of dispatchable workflow components without requiring modification of other elements within the same dispatchable workflow component.

Modification of the dispatchable workflow components may occur for various purposes throughout the execution process of a machine learning workflow. For example, developers may retrain a machine learning model on new, updated, or modified training data, thus requiring that the process logic component of a dispatchable workflow component be updated (e.g., with updated model parameters). In another example, a dispatchable workflow component may fail to execute, and the execution system 110 may modify the dispatchable workflow component for a subsequent attempt at execution to use a different execution context that provides additional monitoring, breakpoints, or intermediate data snapshots to be captured while using the same process logic component and dispatch component. In another example, a dispatchable workflow component may be sent to a new worker environment 116 (e.g., if a new worker environment is online and available), and may thus require a dispatch configuration corresponding to the new worker environment. In each of these cases, the execution system 110 may modify the respective element of a dispatchable workflow component without modifying the other elements.

The execution system 110 transmits the dispatchable workflow elements and/or instructions for executing the dispatchable workflow elements to the worker environments 116 and storage system 118 via a network 120. In various embodiments, the network 120 uses standard communications technologies and/or protocols. For example, the network 120 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

Worker environments 116A-B may be any suitable device or system for executing a dispatchable workflow component (and its respective process logic). For example, a worker environment 116 may be a cloud computing system or other remote computing system capable of receiving and executing machine learning models or other process logic. In some embodiments, worker environments 116 may be virtual machines or containers accessed by the execution system on a remote computing system. The worker environments 116 in some examples may also include execution contexts local to the execution system 110. Worker environments 116 may have various specifications and resources for executing machine learning workflows, which may be provided to the execution system 110 for determining how and when dispatchable workflow components are distributed for execution. Different worker environments 116 may operate on different cloud provider services and provide (or access) resources in different ways. For example, one worker environment 116A may provide a computing environment including primarily serialized processing with process threads such as a centralized computing unit (CPU) while a second worker environment 116B may provide a computing environment with additional resources specialized in parallelized or matrix operations such as a graphics processing unit (GPU) or AI accelerators (e.g., a neural processing unit (NPU) or tensor processing unit (TPU)). Different worker environments 116 (particularly when disposed across different cloud providers) may also provide different operating systems, available system operations, local configurations, and so forth.

In some embodiments, the worker environments 116 are accessed by the execution system 110 via an intermediary system, such as a portal or other cloud services management system. The intermediary system may be responsible for identifying available machines within a cloud computing system, instantiating containers or other virtual machines for executing requested processes, and so forth. In these instances, the execution system 110 may send requests to the intermediary system for initiating a workflow component, and the intermediary system 110 sends the task to a worker environment, which may include instantiating the worker environment 116. In these and other circumstances, direct communication between the execution system 110 and then worker environment may be one-way, such that the execution system 110 may provide a task to be performed (or a location for relevant information about the task to be accessed) by the worker environment (e.g., via the intermediary system), but the worker environment does not directly respond or provide additional messaging to the execution system 110 (e.g., to describe task receipt, progress, or confirm completion). As discussed further below, in certain embodiments the worker environment 116 may record output results from an allocated workflow component to the storage system 118. The execution system 110 may then monitor the storage system 118 to determine when an assigned workflow component is completed.

The storage system 118 receives and stores data, including process logic, execution context, and dispatch configuration for execution of machine learning workflows, from the execution system 110 via the network 120. The storage system 118 may additionally receive and store input data for one or more workflow components and/or output data generated by executing one or more workflow components.

In some embodiments, the storage system 118 is a joint storage location for the execution system 110 and the one or more worker environments 116, such that data stored by the execution system or the worker environments may be accessed by other systems within the environment 100. This enables data, such as workflow components and output data from execution of workflow components, to be accessed by the execution system 110 or the one or more worker environments 116.

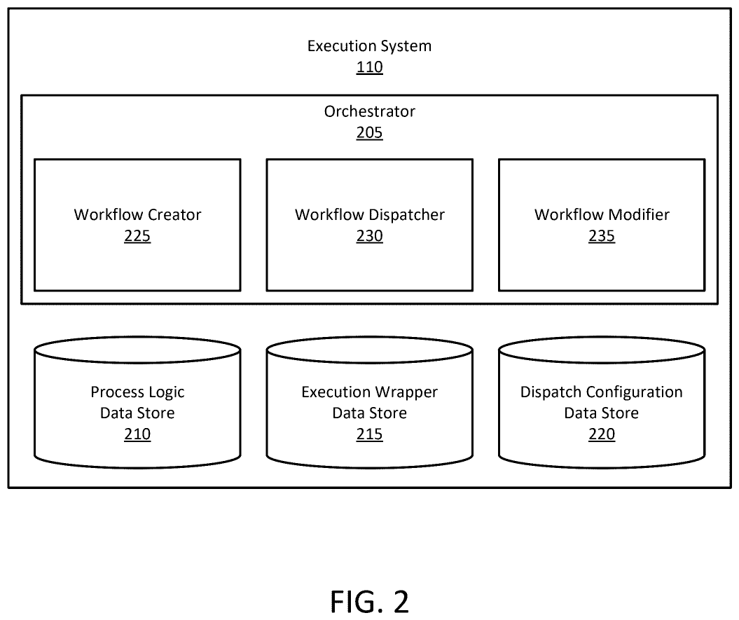

FIG. 2 is an example block diagram of an execution system 110, according to one embodiment. The execution system 110 comprises an orchestrator 205, a process logic data store 210, an execution wrapper data store 215, and a dispatch configuration data store 220. In other embodiments, different and/or additional components may be included in the execution system 110.

Machine learning process pipelines are composed of multiple logical steps or process logic components, which may be machine learning models or any other data processing logic for receiving input data and generating output data based on the input data. The process logic components in machine learning process pipelines may have varying data dependencies, e.g., such that the output data of one process logic component is used as an input for a next process logic component, thus requiring that the corresponding process logic components must be executed sequentially. Further, process logic components within a machine learning process pipeline may have different requirements for execution (e.g., being memory intensive or requiring auditability or monitoring during execution).

The orchestrator 205 coordinates execution of machine learning process pipelines received by the execution system 110. The orchestrator 205 receives machine learning process pipelines and enables the pipelines to be executed flexibly across one or more worker environments. The orchestrator 205 comprises a workflow creator 225, a workflow dispatcher 230, and a workflow modifier 235. In other embodiments, different and/or additional components may be included in the orchestrator 205.

The workflow creator 225 generates machine learning workflows from machine learning process pipelines. Machine learning workflows are the set of dispatchable workflow components that may be dispatched to worker environments to execute components of a machine learning process pipeline in worker environments with appropriate execution wrappers and dispatch configurations. The workflow creator 225 identifies the set of process logic components, their corresponding data dependencies, and other relevant metadata of a received machine learning process pipeline. In some embodiments, the workflow creator 225 stores the process logic components and metadata in the process logic data store 210.

The workflow creator 225 generates a machine learning workflow based on the set of process logic components. The workflow creator 225 selects, for each process logic component, an execution wrapper from the execution wrapper data store 215 and a dispatch configuration from the dispatch configuration data store 220. In various embodiments, the workflow creator 225 selects execution wrapper and dispatch configuration based on requirements or characteristics of the respective process logic component and/or requirements or characteristics of a worker environment, e.g., to include auditing or monitoring capabilities to the execution wrapper or to include networking and system configurations in a dispatch configuration. The generated machine learning workflow comprises a set of dispatchable workflow components, each dispatchable workflow component including the respective process logic component, the execution wrapper, and the dispatch configuration. Each dispatchable workflow component is logically separate from other dispatchable workflow components of the machine learning workflow, such that they may be dispatched separately to one or more worker environments; however, data dependencies associated with the machine learning process pipeline are maintained by the dispatchable workflow components. In various embodiments, workflow creator 225 may use metadata associated with the dispatchable workflow components to maintain data dependencies between the components.

The workflow creator 225 stores the generated machine learning workflow for execution. In some embodiments, the workflow creator 225 stores the machine learning workflow in the execution system 110 (e.g., for local execution). In other embodiments, the workflow creator 225 transmits the machine learning workflow to an external or remote storage location (e.g., a cloud storage system or other suitable shared storage location) accessible by the execution system 110 and one or more worker environments 116.

The workflow dispatcher 230 coordinates execution of the machine learning workflow by transmitting instructions to the one or more worker environments 116 to execute dispatchable workflow components. The workflow dispatcher 230 identifies when dispatchable workflow components are ready to be executed and which appropriate worker environments are available to execute the dispatchable workflow components. The workflow dispatcher 230 may identify appropriate workflow components for dispatchable workflow components based on resources available or processing capacities of various worker environments and requirements of the respective dispatchable workflow components. For example, the workflow dispatcher 230 determines whether a worker environment meets a minimum threshold of available memory storage for a dispatchable workflow component with memory intensive process logic. When an appropriate worker environment is available, the workflow dispatcher 230 transmits instructions to worker environments to retrieve and execute the respective dispatchable workflow components.

In some embodiments, the workflow dispatcher 230 directly transmits the dispatchable workflow component to worker environments with instructions to execute the dispatchable workflow component. In other embodiments, the workflow dispatcher 230 transmits a storage location associated with the dispatchable workflow component (e.g., on a storage system 118) for worker environments to retrieve and execute the dispatchable workflow component. The storage location of the dispatchable workflow component may be specified, for example, in a hypertext transfer protocol (http) request as a portion of the request string. The worker environment may access the specified storage location to retrieve the applicable dispatchable workflow component from the specified storage location (e.g., after providing relevant access credentials) and begin executing the dispatchable workflow component. This enables the workflow dispatcher 230 to initiate execution of a dispatchable workflow component by providing a link or reference to the dispatchable workflow component in standard messages and with minimal overhead.

As previously discussed, dispatchable workflow components may be dispatched separately to one or more worker environments but are executed such that data dependencies of the original machine learning process pipeline are maintained. That is, while some dispatchable workflow components may be executed in parallel, dispatchable workflow components that depend on outputs from other dispatchable workflow components must be executed sequentially based on the data dependencies. The workflow dispatcher 230 identifies and ensures the data dependencies are maintained, even if the corresponding dispatchable workflow components are executed in different worker environments 116, by monitoring execution of each dispatchable workflow component.

In some embodiments, the workflow dispatcher 230 monitors execution of dispatchable workflow components by monitoring a storage location for output data of the worker environments 116. When new output data is provided to the storage location, the workflow dispatcher 230 determines the dispatchable workflow component has been successfully executed, and thus the output data may be used as input for the dependent dispatchable workflow component or passed to other downstream processes. Thus, the workflow dispatcher 230 transmits a next instruction to execute the dependent dispatchable workflow component to an appropriate worker environment. If new output data is not provided to the storage location after an expected amount of time for execution has passed, the workflow dispatcher 230 may determine that the dispatchable workflow component has failed to execute. Thus, the workflow dispatcher 230 may transmit instructions to rerun the dispatchable workflow component, to execute the dispatchable workflow component on a different worker environment, and/or to modify the dispatchable workflow component (e.g., to modify the execution wrapper and use an execution wrapper with additional monitoring and/or logging capabilities).

In various embodiments, the workflow modifier 235 modifies one or more elements of dispatchable workflow components of machine learning workflows. The workflow modifier 235 may modify dispatchable workflow components for various reasons or in response to various triggers. For example, the workflow modifier 235 updates process logic of a dispatchable workflow component responsive to a user of the execution system 110 modifying the machine learning process pipeline from which the machine learning workflow is generated, updating model parameters, or adding or removing processing steps. In another example, as previously discussed, the workflow modifier 235 may modify dispatchable workflow components responsive to a failed execution, e.g., modifying an execution wrapper associated with the failed execution to include increased monitoring processes or modifying a dispatch configuration such that the dispatchable workflow component may be executed on a different worker environment or to access additional resources or functions of the original worker environment. In another example, the workflow modifier 235 may modify a workflow initially under development that used a local environment and an execution wrapper with relatively high logging/monitoring. Once ready for broader deployment, the same core components for the ML pipeline (i.e., its processing logic) can easily be modified for another environment by modifying the associated dispatchable workflow components for deployment to worker environments, maintaining the process logic of the original component, and modifying the execution wrapper to lessen the monitoring requirements.

Because the elements of the dispatchable workflow component are logically distinct (e.g., such that the code of the process logic component is not reliant upon the code of the execution wrapper or dispatch configuration), the workflow modifier 235 may modify an element of the dispatchable workflow component without modifying the other elements and enable independent modification of side effects and execution environments from the machine learning processing logic.

The process logic data store 210 stores process logic components of machine learning process pipelines. Process logic components may be any execution logic of the machine learning process pipeline, such as processing or machine-learning layers for transforming or processing an input to a respective workflow component into an output. For example, process logic components may be one or more machine learning models trained to receive input data and to generate output predictions, such as recommendation models for presenting items or content to users of online systems, diagnostic models for predicting risk or assessing changes in medical or scientific fields, or the like. In various embodiments, process logic components may include one or more of a generalized linear model, a generalized additive model, a random forest classifier, a spatial regression operation, a Bayesian regression model, a time series analysis, a Bayesian network, a Gaussian network, a decision tree learning operation, an artificial neural network, a recurrent neural network, a reinforcement learning operation, linear or non-linear regression operations, clustering operations, support vector machines, or genetic algorithm operations.

In various embodiments, process logic components may additionally or instead be one or more data processing functions. Data processing functions may perform various transformations to input data, which may include data gathering, consolidation, cleaning, or deduplication; generating data embeddings or data features describing input data; modifying data or data formatting, such as resizing, simplifying, or applying transformations to input data; or selecting representative data points from input data (e.g., data smoothing). In some embodiments, process logic components may include one or more data processing functions and a machine learning model.

Each process logic component may be associated with metadata describing the process logic component. For example, process logic components may be associated with an identifier of a machine learning process pipeline it is associated with, a type of input and/or output data, or one or more data dependencies associated with process logic components.

The process logic components thus include the processing of data for application of a machine learning model, such as the steps to generate features for computer model input and applying one or more tunable computer model layers to process the features to an output. These process logic components may thus be distinct from functions of the execution wrapper, which may provide additional monitoring, logging, auditing, and other supervisory or auditing capabilities relative to the “core” process of the machine learning pipeline.

The execution wrapper data store 215 stores execution wrappers for machine learning workflows. The orchestrator 205 may select execution wrappers for use in dispatchable workflow components when generating a machine learning workflow. Execution wrappers add pre-or post-execution logic to be executed alongside process logic, allowing dispatchable workflow components to generate side effects or gather metadata during execution. Execution wrappers may create unique identifiers for execution “runs” of a dispatchable workflow component, mark input and output data with unique identifiers for versioning, serialize process logic components for reproducibility, store lineages of input data for auditing purposes, or write runtime logs and metrics so that execution of dispatchable workflow components may be monitored. Thus, execution wrappers may be used to implement various monitoring or auditing functions for dispatchable workflow components and troubleshoot dispatchable workflow components if attempted execution is unsuccessful.

The dispatch configuration data store 220 stores dispatch configurations for machine learning workflows. The orchestrator 205 may pair dispatch configurations with process logic components in dispatchable workflow components based on a worker environment in which the dispatchable workflow component will be executed. Dispatch configurations may reference specific environments and include logic for sending and receiving the dispatchable workflow component and associated input and output data to the corresponding environment. In some embodiments, dispatch configurations include logic enabling worker environments to execute dispatchable workflow components as though all elements of the dispatchable workflow component are run locally.

In various embodiments, the dispatch configuration data store 220 includes a local configuration enabling dispatchable workflow components to be run on a local computing environment of the execution system 110. In various embodiments, the dispatch configuration data store 220 includes one or more dispatch configurations enabling dispatchable workflow components to be run in large data processing environments (e.g., Databricks Spark clusters). In various embodiments, the dispatch configuration data store 220 includes one or more dispatch configurations enabling dispatchable workflow components to be run in environments for model training or inference workloads (e.g., Azure ML). In other embodiments, the dispatch configuration data store 220 may include other dispatch configurations corresponding to any other suitable worker environment, e.g., various cloud computing services, virtual machines, or the like. These may include system configurations, storage data locations for data input or output, storage data or other access keys, and other configuration data for a particular worker environment to execute the execution wrapper and process logic accompanying the dispatch configuration in a dispatchable workflow component.

### Generating Machine Learning Workflows

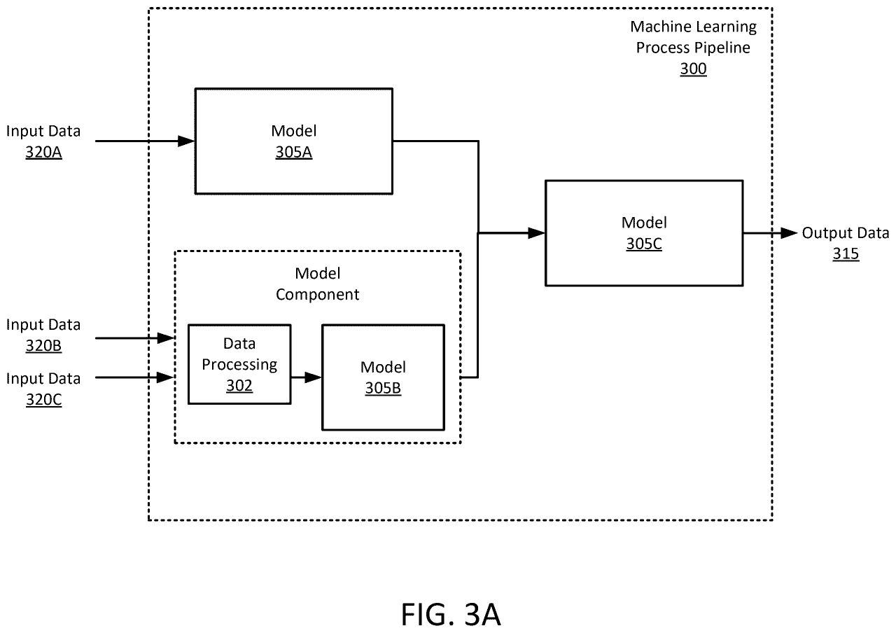

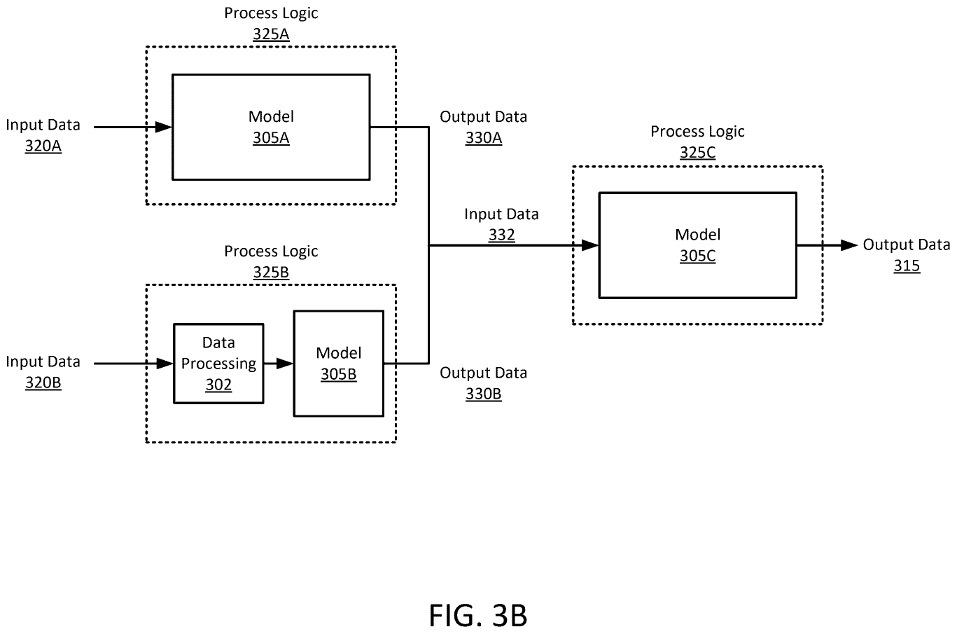

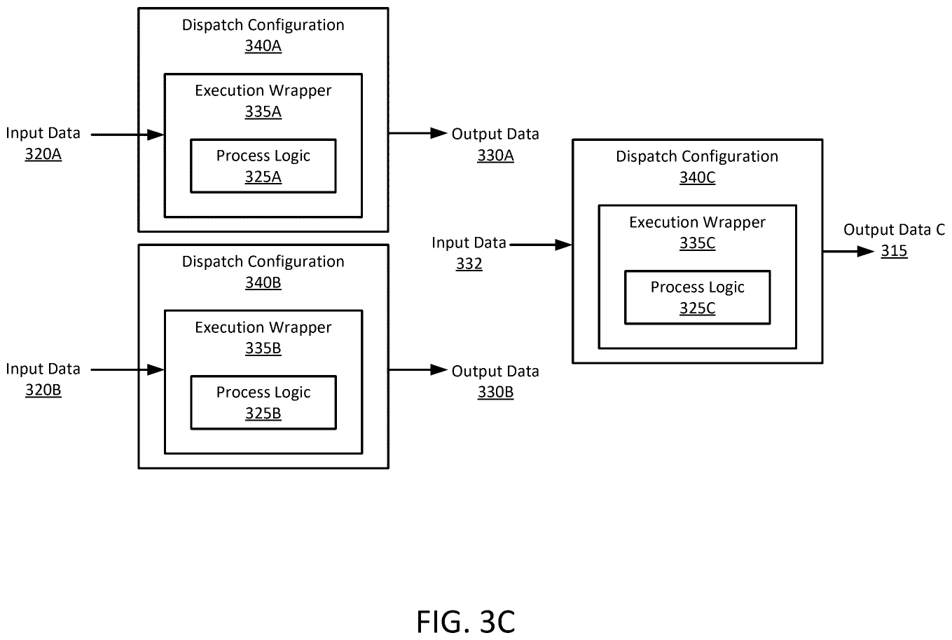

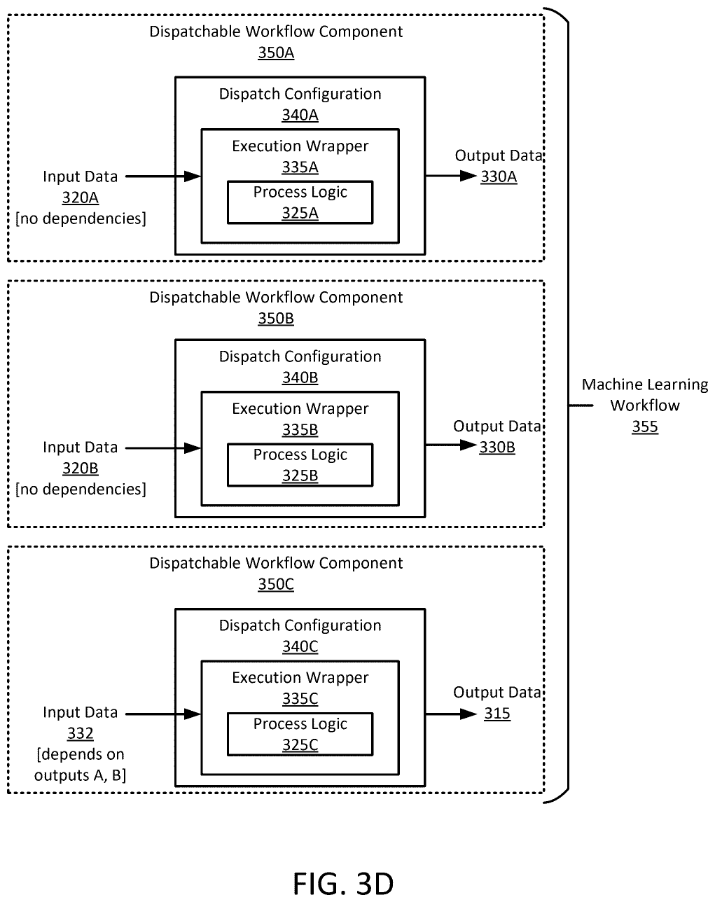

FIG. 3A illustrates an example machine learning process pipeline 300, according to one embodiment. A machine learning process pipeline consists of multiple model components for processing or transforming data. In one embodiment, the machine learning process pipeline may form a directed acyclic graph (DAG) of the constituent model components. Each model component may be a processing step and/or a machine learning model, such that input data is received by the machine learning process pipeline and transformed through the machine learning process pipeline 300 to generate output data. In other embodiments, a machine learning process pipeline may include fewer or additional model components than is shown in the example of FIG. 3A, and the model components may have different dependencies, inputs, or outputs than shown here.

The example machine learning process pipeline 300 consists of three machine learning models 305 and a data processing step 302. The data processing step 302 may perform one or more data processing functions for the machine learning process pipeline 300. In some embodiments, as in the example shown, the data processing step 302 may be associated with a particular machine learning model 305B of the machine learning process pipeline 300, such that the data processing is performed to provide suitable input data to the machine learning model. In various examples, the data processing step may include one or more of: data gathering, consolidation, cleaning, or deduplication; generating data embeddings or data features describing input data; modifying data or data formatting, such as resizing, simplifying, or applying transformations to input data; selecting representative data points from input data (e.g., data smoothing), or the like.

The machine learning models 305 may be any model trained to receive one or more sets of input data and to transform or process the inputs to generate output data. For example, the machine learning models 305 may be one or more of: a generalized linear model, a generalized additive model, a random forest classifier, a spatial regression operation, a Bayesian regression model, a time series analysis, a Bayesian network, a Gaussian network, a decision tree learning operation, an artificial neural network, a recurrent neural network, a reinforcement learning operation, linear or non-linear regression operations, clustering operations, support vector machines, or genetic algorithm operations.

The machine learning process pipeline 300 of FIG. 3A receives three sets of input data (320A, B, C) and generates output data 315 by executing three model components: A model 305A, a data processing step 302 and model 305B, and a model 305C. Model 305C is dependent on models 305A, B, such that output data from the models 305A, B are used as input by the model 305C. In conventional systems, all components of the machine learning process pipeline 300 are executed within one system or environment, allowing the output data from models 305A, B to be provided directly as input to model 305C. Model 305C in turn generates output data 315, which may be stored or used in downstream processing or decision making.

In one example for the architecture of FIG. 3, the machine learning process pipeline 300 may be a recommendation model for an online system trained to generate an affinity score based on item and user features. The affinity score may be used in various downstream processes by the online system, such as selecting items of the online system to present to a user, where it is beneficial for an online system to display items with higher affinity scores to users and provide relevant items to users (e.g., responsive to search requests). This example model pipeline separately processes information about a user (by model 305A) and an item (by model 305B) to generate representations of the user and the item and then combines the respective representations to generate an overall score (by model 305C). In this example, the machine learning process pipeline 300 receives a set of user input data 320A including user characteristics, user item preferences, user interaction history, etc., and sets of item input data 320B, C including descriptive information about items, item review information, item interaction data, etc., and outputs one or more affinity scores describing a likelihood of user interaction with items of the example online system.

Within the example machine learning process pipeline 300, the first model 305A is trained to receive the set of user input data 320A and to output a set of user features or user embeddings. The data processing step 302 may be performed on the sets of item input data 320B, C, for example, to consolidate the sets of item input data to a single set of input data. The second model 305B is trained to receive the processed set of input data from the data processing step 302 and generates a set of item features or item embeddings. The set of user features and the set of item features are then provided to model 305C, which is trained to generate affinity scores based on user and item representations.

FIGS. 3B-D illustrate an example process by which a machine learning process pipeline 300 is used to generate a machine learning workflow consisting of multiple dispatchable workflow components, according to one embodiment. The machine learning process pipeline 300 of FIG. 3A is received by an execution system 110. The execution system 110 converts the machine learning process pipeline 300, consisting of multiple model components 305A-C, into a machine learning workflow consisting of dispatchable workflow components, such that the dispatchable workflow components may be transmitted to various worker environments for execution.

In particular, FIG. 3B illustrates a conversion of a machine learning process pipeline 300 to process logic components 325A-C, according to one embodiment. In various embodiments, the execution system 110 generates process logic components 325 corresponding to each model component 305A-C of the machine learning process pipeline 300. Process logic components 325 may represent a single data processing step or machine learning model or may combine one or more processing data steps and one or more machine learning models. For example, the data processing step 302 and model 305B may be combined into a single process logic component 325B having input data 320B and output data 330B.

Because process logic components 325 are logically distinct from each other within a machine learning workflow, each process logic component is associated with input data 320A-B, 332 and output data 315, 330A-B. However, process logic components 325 maintain data dependencies that similarly correspond to the model components of the machine learning process pipeline 300. As such, process logic 325A, corresponding to model 305A, receives input data 320A and generates output data 330A. Process logic 325B, corresponding to data processing 302 and model 305B, receives input data 320B and generates output data 330B. Output data 330A and output data 330B are identified by the execution system 110 as corresponding to input data 332 based on the data dependency between model 305C and the previous models 305A, B. Thus, process logic 325C, corresponding to model 305C, receives input data 332 and generates output data 315.

FIG. 3C illustrates an example set of dispatchable workflow components corresponding to a machine model process pipeline 300, according to one embodiment. Once the execution system 110 isolates the process logic components 325A-C of the machine learning process pipeline 300, the process logic components are separately wrapped with execution wrappers 335A-C and dispatch configurations 340A-C to generate dispatchable workflow components. The execution wrappers 335 and dispatch configurations 340 may be selected by the execution system 110 based on requirements of corresponding process logic components 325 or of worker environments. Execution wrappers 335, for example, which dictate pre- and post-execution logic, may be selected by the execution system to generate auditable logs during execution of process logic 325, to monitor execution of process logic for failure or error, to generate specific metadata during execution of process logic such as timestamps, identifiers, etc., or to perform other processing functions prior to or after execution of the process logic. Similarly, dispatch configurations 340 may be selected by the execution system 110 based on a worker environment in which the dispatchable workflow component will be executed.

While the example of FIG. 3C illustrates separate dispatch configurations (340A, B, C) and execution wrappers (335A, B, C) for each respective process logic component 325, in other examples, execution wrappers and/or dispatch configurations may be used for multiple process logic components, as execution wrappers and dispatch configurations are logically separate from the process logic itself and thus does not need to be individually generated or modified for the process logic.

The execution system 110 additionally stores information describing data dependencies for the machine learning process pipeline but enables separation of the dispatchable workflow components. Thus, while process logic 325C relies on output data 330A and output data 330B as input data 332, the dispatchable workflow component corresponding to process logic 325C does not necessarily need to be executed in the same worker environment as process logic 325A or 325B; rather, the execution system 110 ensures that process logic 325C is not executed until its dependencies are successfully executed.

FIG. 3D illustrates an example machine learning workflow 355, according to one embodiment. The generated machine learning workflow 355 includes the set of dispatchable workflow components 350A-C, which may be independently executed by the execution system 110 on one or more worker environments. Each dispatchable workflow component 350 includes a process logic component 325A-C, an execution wrapper 335A-C, and a dispatch configuration 340A-C, and is associated with a set of input data 320A-B, 332 and expected output data 315, 330A-B. The execution system 110 additionally maintains data dependencies within the machine learning workflow 340, e.g., identifying that the dispatchable workflow component 350C receives input data 332 which depends on output data 330A, B, to ensure that execution of the dispatchable workflow components occurs in a correct order.

In various embodiments, elements of each dispatchable workflow component 350 may be independently modified or substituted by the execution system 110. Modification or substitution may occur for various reasons. For example, a user of the execution system 110 may recode or update process logic 325 of a dispatchable workflow component 350, e.g., by retraining a machine learning model, updating code of the process logic, or the like. In another example, it may be necessary to execute a dispatchable workflow component 350 at a new worker environment, e.g., if a remote worker environment is not available, thus requiring that the dispatch configuration 340 be modified or changed based on the new worker environment. In another example, it may be beneficial to include additional monitoring or auditing functions to a dispatchable workflow component 350 if, e.g., an audit log is required by a user of the execution system 110, an error previously occurred which prevented successful execution of the dispatchable workflow component, or the like.

### Executing Machine Learning Workflows

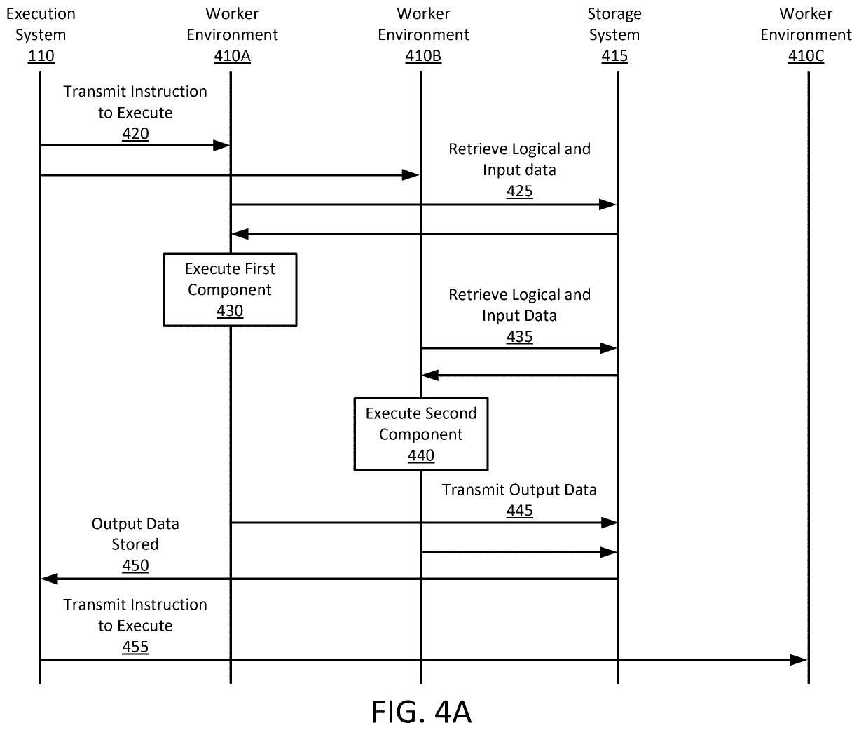

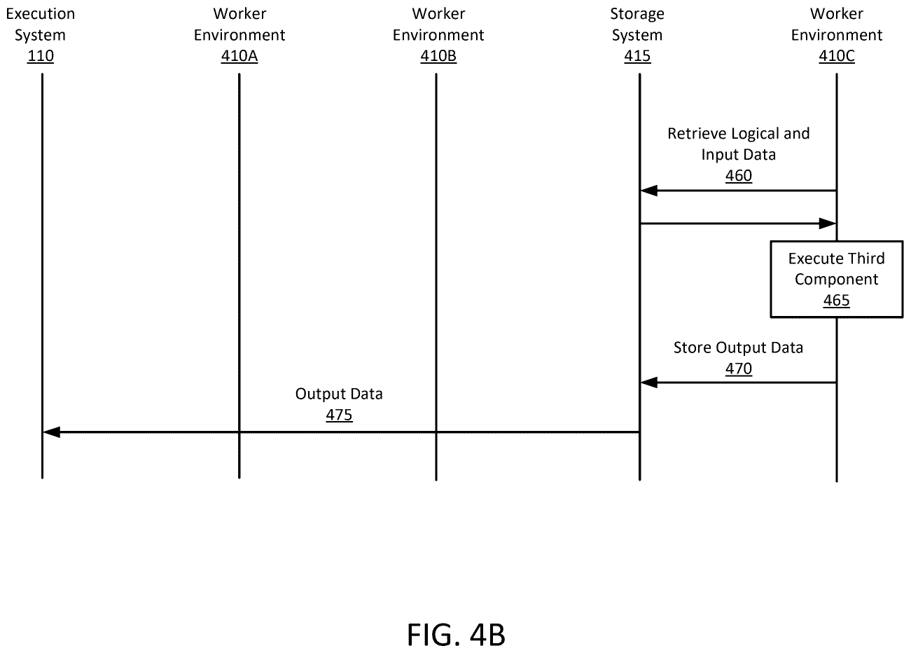

FIGS. 4A-B are an example timing diagram for executing a machine learning workflow by an execution system 110, according to one embodiment. The timing diagram of FIGS. 4A-B illustrates execution of the machine learning workflow of FIGS. 3A-D, or a similar machine learning workflow. In other examples, machine learning workflows may have fewer, additional, or different dispatchable workflow components, may be transmitted to fewer, additional, or different worker environments, or may have fewer, additional, or different data dependencies impacting the interactions described herein.

The execution system 110, or an orchestrator of the execution system, such as orchestrator 205, transmits 420 instructions to execute dispatchable workflow components to worker environments 410A, B. The instructions may include, for example, an identifier of a dispatchable workflow component to be executed, a storage location on the storage system 415 of the dispatchable workflow component, one or more storage locations of input data for the dispatchable workflow component, and so on.

The worker environment 410A retrieves 425 logical and input data from the storage system 415 and executes 430 a first dispatchable workflow component. The worker environment 410B retrieves 435 logical and input data from the storage system 415 and executes 440 a second dispatchable workflow component. In the example of FIG. 4A, worker environments 410A, B perform the respective operations sequentially; however, in other examples, because the first component and second component do not share data dependencies, worker environments may perform the respective operations in parallel. The worker environments 410A, B transmit 445 the output data to be stored into the storage system 415 upon successful execution of the respective dispatchable workflow components.

In various embodiments, communication between the execution system 110 and the storage system 415 may be unidirectional, such that the storage system is unable to notify the execution system when output data is stored by worker environments. Rather, the execution system 110 monitors the storage system 415 to determine when output data is stored 450, indicating that the dispatchable workflow components have been successfully executed. Responsive to determining that the output data is stored 450 and is thus available to be used, the execution system 110 then transmits 455 an instruction to execute a dispatchable workflow component to a third worker environment 410C.

As shown in FIG. 4B, the third worker environment 410C retrieves 460 logical and input data from the storage system 415. Continuing the data dependencies discussed in conjunction with FIGS. 3A-D, input data for the third dispatchable workflow component is output data from the previously executed first and second dispatchable workflow components. The worker environment 410C executes 465 the third dispatchable workflow component and stores 470 the generated output data to the storage system 415.

When the output data is successfully stored, the execution system 110 may monitor the storage system 415 to identify that the third dispatchable workflow component has been successfully executed, thus completing execution of the example machine learning workflow. Output data 475 from the third dispatchable workflow component may be retrieved by the execution system 110 and applied to other downstream processes or decision-making, or the execution system may notify a user or downstream system about completion of the machine learning workflow.

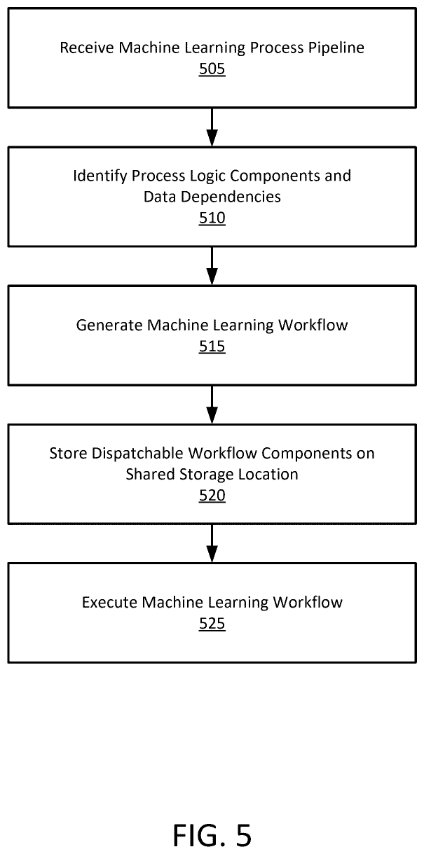

FIG. 5 is an example flow diagram illustrating a method for generating and executing a machine learning workflow, according to one embodiment. The steps of FIG. 5 may be performed by the execution system 110, though in other embodiments, some or all of the steps may be performed by other entities or systems. In addition, other embodiments may include different, additional, or fewer steps, and the steps may be performed in different orders.

The execution system 110 receives 505 a machine learning process pipeline. The machine learning process pipeline may be provided by a user of the execution system 110 and is configured to receive one or more sets of input data and to generate one or more outputs. Inputs to the machine learning process pipeline may be raw data or may be data processed by other upstream processes. Outputs from the machine learning process pipeline may be used in various downstream processes or in later decision making.

The execution system 110 identifies 510 a set of process logic components of the machine learning process pipeline. Each process logic component may be a data processing step or function, a machine learning model, or both. Further, the execution system 110 identifies data dependencies between process logic components of the machine learning process pipeline. That is, process logic components of the machine learning process pipeline may may use output data of a different “previous” process logic component as input. Some process logic components may have multiple data dependencies from multiple previous logic components. Where data dependencies occur, dependent process logic components cannot be executed until the previous process logic components are successfully executed.

The execution system 110 generates 515 a machine learning workflow from the identified process logic components. The machine learning workflow consists of a set of dispatchable workflow components, wherein each of the dispatchable workflow components corresponds to a process logic component of the set of identified process logic components. The dispatchable workflow components include the respective process logic component, dictating the data processing or model prediction for the dispatchable workflow component; an execution context, applying pre-or post-execution logic; and a dispatch configuration, interfacing between a particular worker environment and the other elements of the dispatchable workflow components.

In various embodiments, the elements of the dispatchable workflow components (e.g., the process logic, execution context, and dispatch configuration) are logically distinct from each other, and thus separately modifiable.

The execution system 110 stores 520 the dispatchable workflow components on a shared storage location. The shared storage location may be any suitable storage system that is accessible to the execution system 110 and one or more worker environments 116. In some embodiments, communication between the execution system 110 and the shared storage location is unidirectional, such that the execution system may store data to the shared storage location and monitor the shared storage location for changes but cannot receive information from the shared storage location.

Once the dispatchable workflow components are stored, the execution system 110 executes 525 the machine learning workflow by transmitting instructions to one or more worker environments 116 to execute the dispatchable workflow components. The worker environments 116 may be one or more remote workspaces, such as, for example, cloud computing services or virtual machines run on remote systems. The worker environments 116 may provide resources or other benefits that are unavailable on the native execution system, such as, for example, memory or CPU usage, accessibility or transparency, etc. The instructions to the one or more worker environments 116 may include instructions to retrieve a dispatchable workflow component from the shared storage location, to retrieve input data from the shared storage location, to execute the dispatchable workflow component, and/or to store output data from executing the dispatchable workflow component to the shared storage location. In some embodiments, communication between the execution system 110 and one or more of the worker environments 116 may be unidirectional, such that the execution system may transmit instructions to the worker environments but cannot receive notifications or information from the worker environments.

In embodiments where the execution system 110 is unidirectionally communicative with the shared storage location and/or the one or more worker environments 116, the execution system may monitor the shared storage location to determine whether execution of a dispatchable workflow component is complete. Accurately determining when a dispatchable workflow component is successfully executed is particularly important during machine learning workflows with one or more data dependencies, as errors may otherwise occur when dispatchable workflow components are unable to access needed input data. When the execution system 110 identifies that execution of the dispatchable workflow component is complete, the execution system may then transmit a next instruction to execute one or more dependent dispatchable workflow components.

### Conclusion

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. An execution system comprising:
a processor; and
a non-transitory computer-readable storage medium having instructions executable by the processor for:
identifying a set of process logic components of a machine learning process pipeline and, for each process logic component, data dependencies;
generating a machine learning workflow comprising a set of dispatchable workflow components corresponding to the set of process logic components, each dispatchable workflow component comprising the respective process logic component, an execution context, and a dispatch configuration;
storing the dispatchable workflow components on a shared storage location accessible by a set of worker environments; and
executing the machine learning workflow by transmitting, to one or more worker environments, an instruction to execute the dispatchable workflow components.

2. The system of claim 1, wherein the instructions for the execution system are further executable for:
monitoring the shared storage location to determine whether the instruction to execute the dispatchable workflow component is complete; and
responsive to identifying that execution of the dispatchable workflow component is completed, transmitting a next instruction to execute a dependent dispatchable workflow component of the set of dispatchable workflow components.

3. The system of claim 1, wherein one or more of the worker environments are located on cloud environments separate from the execution system.

4. The system of claim 1, wherein one or more of the worker environments are virtual machines.

5. The system of claim 1, wherein communication between the execution system and the shared storage location is unidirectional.

6. The system of claim 1, wherein communication between the execution system and one or more of the worker environments is unidirectional.

7. The system of claim 1, wherein, for each dispatchable workflow component, the respective process logic component, the execution context, and the dispatch configuration are logically distinct and separately modifiable.

8. The system of claim 1, wherein the process logic component is a machine learning model.

9. A method for an execution system, comprising:
identifying a set of process logic components of a machine learning process pipeline and, for each process logic component, data dependencies;
generating a machine learning workflow comprising a set of dispatchable workflow components corresponding to the set of process logic components, each dispatchable workflow component comprising the respective process logic component, an execution context, and a dispatch configuration;
storing the dispatchable workflow components on a shared storage location accessible by a set of worker environments; and
executing the machine learning workflow by transmitting, to one or more worker environments, an instruction to execute the dispatchable workflow components.

10. The method of claim 9, further comprising:
monitoring the shared storage location to determine whether the instruction to execute the dispatchable workflow component is complete; and
responsive to identifying that execution of the dispatchable workflow component is completed, transmitting a next instruction to execute a dependent dispatchable workflow component of the set of dispatchable workflow components.

11. The method of claim 9, wherein one or more of the worker environments are located on cloud environments separate from the execution system.

12. The method of claim 9, wherein one or more of the worker environments are virtual machines.

13. The method of claim 9, wherein communication between the execution system and the shared storage location is unidirectional.

14. The method of claim 9, wherein communication between the execution system and one or more of the worker environments is unidirectional.

15. The method of claim 9, wherein, for each dispatchable workflow component, the respective process logic component, the execution context, and the dispatch configuration are logically distinct and separately modifiable.

16. The method of claim 9, wherein the process logic component is a machine learning model.

17. A non-transitory computer-readable medium for an execution system, the non-transitory computer-readable medium comprising instructions executable by a processor for:
identifying a set of process logic components of a machine learning process pipeline and, for each process logic component, data dependencies;
generating a machine learning workflow comprising a set of dispatchable workflow components corresponding to the set of process logic components, each dispatchable workflow component comprising the respective process logic component, an execution context, and a dispatch configuration;
storing the dispatchable workflow components on a shared storage location accessible by a set of worker environments; and
executing the machine learning workflow by transmitting, to one or more worker environments, an instruction to execute the dispatchable workflow components.

18. The computer-readable medium of claim 17, wherein the instructions are further executable for:
monitoring the shared storage location to determine whether the instruction to execute the dispatchable workflow component is complete; and
responsive to identifying that execution of the dispatchable workflow component is completed, transmitting a next instruction to execute a dependent dispatchable workflow component of the set of dispatchable workflow components.

19. The computer-readable medium of claim 17, wherein one or more of the worker environments are located on cloud environments separate from the execution system.

20. The computer-readable medium of claim 17, wherein one or more of the worker environments are virtual machines.
